(19) United States
(12) Patent Application Publication
(10) Pub. No.: US 2022/0005345 A1
(43) Pub. Date: Jan. 6, 2022

(54) PEDESTRIAN ALERT DEVICE FOR ELECTRIC VEHICLE

(71) Applicant: SUZHOU SONAVOX ELECTRONICS CO., LTD., Suzhou, Jiangsu (CN)

(72) Inventors: Hongbing DING, Suzhou, Jiangsu (CN); Kaihua QIAN, Suzhou, Jiangsu (CN); Wenwei LIU, Suzhou, Jiangsu (CN); Guoqiang CHAI, Suzhou, Jiangsu (CN); Jianming ZHOU, Suzhou, Jiangsu (CN)

(21) Appl. No.: 17/285,748

(22) PCT Filed: Oct. 14, 2019
(86) PCT No.: PCT/CN2019/111019

§ 371 Date: Apr. 15, 2021

(30) Foreign Application Priority Data
Oct. 17, 2018 (CN) 201821685350.6

(51) Int. Cl. G08G 1/005; E01F 9/529; H05K 5/00; H04R 1/02; G06F 3/06

(52) U.S. Cl. CPC G08G 1/005; E01F 9/529; H04R 2499/13; H04R 1/026; G06F 3/06; H05K 5/0017

(57) ABSTRACT

The present disclosure relates to a pedestrian alert device for an electric vehicle, comprising an accelerator pedal mechanism, a controller, and a sound producing mechanism. The controller is electrically connected to the accelerator pedal mechanism and the sound producing mechanism respectively, and is disposed on the accelerator pedal mechanism. The accelerator pedal mechanism comprises an installation box, an installation base fixedly connected to the installation box, and an accelerator pedal disposed on the installation base, the installation box has a chamber, and the controller is disposed in the chamber of the installation box. The controller is electrically connected to the sound producing mechanism by a wire, and the installation box is provided with a through-hole for the wire to pass through. The pedestrian alert device for an electric vehicle has low cost and a compact structure.

### CROSS REFERENCE TO RELATED APPLICATION(S)

This application claims priority of Chinese Patent Application CN 201821685350.6 filed on Oct. 17, 2018, which is incorporated herein by reference in its entirety.

### TECHNICAL FIELD

The present disclosure relates to a pedestrian alert device for an electric vehicle.

### BACKGROUND

In recent years, as the promotion of energy conservation and emission reduction, the electric vehicle industry has developed rapidly. Since electric vehicles do not have the engines of traditional fuel vehicles, they have relatively low noise when driving at low speeds, which is difficult for pedestrians to notice, thus there is a safety hazard. In a crowded and complex environment, it is easy to cause traffic accidents. Therefore, a type of pedestrian warning device for electric vehicles has developed, which can ensure that when the electric vehicle is driving at a low speed, it can remind pedestrians by simulating sound, so as to avoid the risk of traffic accidents.

In the prior art, a pedestrian warning device for an electric vehicle usually includes a sound producing mechanism such as a loudspeaker, a control unit, and an accelerator pedal mechanism. However, in the existed pedestrian warning device, the three parts, namely, the sound producing mechanism, the controller unit, and the accelerator pedal mechanism are separately arranged in different portions of the vehicle, especially the control unit and the accelerator pedal mechanism need to exchange data frequently, but they are independently arranged and far apart, and the data transmission process therebetween is complicated, the cost is extremely high, and the structure is not compact enough.

### SUMMARY

Aimed at the above-mentioned problems, the present disclosure provides a pedestrian alert device for an electric vehicle having low cost and a compact structure.

To achieve the above purpose, a technical solution employed by the present disclosure is:

a pedestrian alert device for an electric vehicle, comprising an accelerator pedal mechanism, a controller and a sound producing mechanism, and the controller is electrically connected to the accelerator pedal mechanism and the sound producing mechanism, respectively, and is disposed on the accelerator pedal mechanism.

In an embodiment, the accelerator pedal mechanism comprises an installation box, an installation base fixedly connected to the installation box, and an accelerator pedal disposed on the installation base, the installation box has a chamber, and the controller is disposed in the chamber of the installation box.

In an embodiment, the controller is electrically connected to the sound producing mechanism by a wire.

In an embodiment, the installation box is provided with a through-hole for the wire to pass through.

In an embodiment, the installation box is a wooden box.

In an embodiment, the sound producing mechanism comprises a housing and a loudspeaker mounted within the housing.

In an embodiment, the sound producing mechanism further comprises a grille cover for protecting the loudspeaker, and the grille cover is fixedly arranged on the housing.

In an embodiment, the housing is arranged on a bumper on a front side of the vehicle.

In an embodiment, the accelerator pedal mechanism further comprises an accelerator pedal signal conversion output device for outputting an accelerator pedal signal according to accelerator pedaling angle and strength; the controller comprises a signal processing audio device for receiving the accelerator pedal signal and processing a pre-stored audio signal to output an audio signal corresponding to a current accelerator pedaling angle and strength; the sound producing mechanism is used to emit a warning sound according to the audio signal output by the controller.

In an embodiment, the controller further comprises a storage device for storing the pre-stored audio file.

Compared with the prior art, the technical solutions employed by the present disclosure have the following advantages:

it can remind pedestrians by simulating sound to avoid the risk of traffic accidents and have an intuitive driving feeling for the driver when driving an electric vehicle, which can also avoid the risk of driver fatigue while increasing the driving pleasure of driving an electric vehicle; integrating the controller on the accelerator pedal mechanism facilitates data transmission between the controller and the accelerator pedal mechanism, improves efficiency, and has a lower cost and a compact structure.

### BRIEF DESCRIPTION OF THE DRAWINGS

For more clearly explaining the technical solutions of the present disclosure, the accompanying drawings used to describe embodiments are simply introduced in the following. Apparently, the below described drawings merely show a part of the embodiments of the present disclosure, and those skilled in the art can obtain other drawings according to the accompanying drawings without creative work.

FIG. 1 is a schematic structural diagram of a pedestrian alert device for an electric vehicle according to an embodiment of the present disclosure.

FIG. 2 is an exploded schematic diagram of the accelerator pedal mechanism and the controller in FIG. 1.

Wherein

1—accelerator pedal mechanism; 11—installation box; 110—through-hole; 12—installation base; 13—accelerator pedal; 2—controller; 3—sound producing mechanism; 31—housing; 32—grille cover; 4—wire.

### DETAILED DESCRIPTION OF EXEMPLARY EMBODIMENTS

In the following, the preferable embodiments of the present disclosure are explained in detail combining with the accompanying drawings so that the advantages and features of the present disclosure can be easily understood by the skilled persons in the art. It should be noted that the explanation on these implementations is to help understanding of the present disclosure, and is not intended to limit the present disclosure.

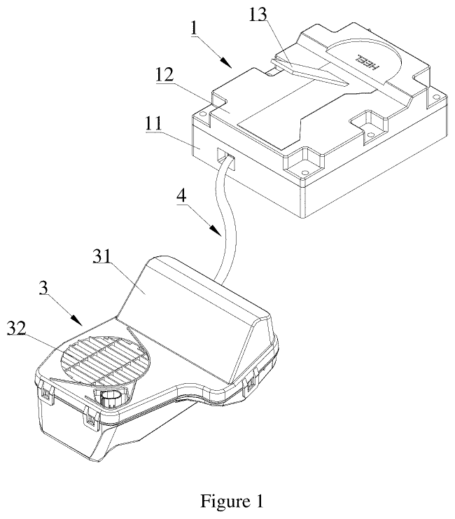

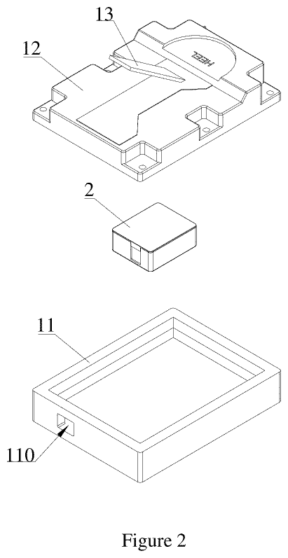

This embodiment aims to provide a pedestrian alert device for an electric vehicle, which can simulate and reproduce car sounds (such as the engine sound of a traditional fuel vehicle) to increase the driving pleasure of the driver when driving an electric vehicle and avoid fatigue driving, and at the same time, it serves as a warning to remind pedestrians around to pay attention to avoidance when at low speeds. Referring to FIG. 1 and FIG. 2, the pedestrian alert device for an electric vehicle, comprises an accelerator pedal mechanism 1, a controller 2 (not shown in FIG. 1) and a sound producing mechanism 3. The controller 2 is electrically connected to the accelerator pedal mechanism 1 and the sound producing mechanism 3, respectively, and the controller 2 is disposed on the accelerator pedal mechanism 1. The controller 2 is installed on the bottom of the vehicle compartment along with the accelerator pedal mechanism 1, and the sound producing mechanism 3 is installed outside the vehicle, preferably on the bumper on the front side of the vehicle.

Referring to FIG. 2, the accelerator pedal mechanism 1 comprises an installation box 11, an installation base 12 fixedly connected to the installation box 11, and an accelerator pedal 13 disposed on the installation base 12, the installation box 11 has a chamber, and the controller 2 is disposed in the chamber of the installation box 11. Specifically, an upper end of the installation box 11 is open, the installation base 12 is fixedly arranged on the upper end of the installation box 11 to close the controller 2 in the installation box 11, and the accelerator pedal 13 is arranged on the upper surface of the installation base 12. The installation base 12 is preferably a wooden box. The accelerator pedal mechanism 1 further comprises an accelerator pedal signal conversion output device for outputting an accelerator pedal signal according to accelerator pedaling angle and strength; the controller 2 comprises a signal processing audio device for receiving the accelerator pedal signal and processing a pre-stored audio signal to output an audio signal corresponding to the current accelerator pedaling angle and strength; the loudspeaker of the sound producing mechanism 3 emits a warning sound according to the audio signal output by the controller 2. Further, the controller 2 further comprises a storage device, and the pre-stored audio file is stored in the storage device.

The controller 2 is electrically connected to the sound producing mechanism 3 by a wire 4. The installation box 11 is provided with a through-hole 110 for the wire 4 to pass through, and the through-hole 110 is opened on a sidewall of the installation box 11.

The sound producing mechanism 3 comprises a housing 31 and a loudspeaker mounted within the housing 31 (not shown in FIG. 1). The sound producing mechanism 3 further comprises a grille cover 32 for protecting the loudspeaker, the grille cover 32 is fixedly arranged on the housing 31, and the housing 31 is arranged on the bumper on the front side of the vehicle. The grille cover 32 has a plurality of evenly distributed vents, the vents are rectangular holes formed by intersecting ribs, which protect the loudspeaker in the housing 31 while facilitating the sound transmission of the loudspeaker, especially for protecting the fragile paper cones of the loudspeaker.

The embodiments described above are only for illustrating the technical concepts and features of the present disclosure, and are intended to make those skilled in the art being able to understand the present disclosure and thereby implement it, and should not be concluded to limit the protective scope of this disclosure.

What is claimed is:

1. A pedestrian alert device for an electric vehicle, comprising an accelerator pedal mechanism, a controller, and a sound producing mechanism, wherein the controller is electrically connected to the accelerator pedal mechanism and the sound producing mechanism, respectively, and is disposed on the accelerator pedal mechanism.

2. The pedestrian alert device according to claim 1, wherein the accelerator pedal mechanism comprises an installation box, an installation base fixedly connected to the installation box, and an accelerator pedal disposed on the installation base, the installation box has a chamber, and the controller is disposed in the chamber of the installation box.

3. The pedestrian alert device according to claim 2, wherein the controller is electrically connected to the sound producing mechanism by a wire.

4. The pedestrian alert device according to claim 3, wherein the installation box is provided with a through-hole for the wire to pass through.

5. The pedestrian alert device according to claim 2, wherein the installation box is a wooden box.

6. The pedestrian alert device according to claim 1, wherein the sound producing mechanism comprises a housing and a loudspeaker mounted within the housing.

7. The pedestrian alert device according to claim 6, wherein the sound producing mechanism further comprises a grille cover for protecting the loudspeaker, and the grille cover is fixedly arranged on the housing.

8. The pedestrian alert device according to claim 6, wherein the housing is arranged on a bumper on a front side of the vehicle.

9. The pedestrian alert device according to claim 1, wherein the accelerator pedal mechanism further comprises an accelerator pedal signal conversion output device for outputting an accelerator pedal signal according to accelerator pedaling angle and strength; the controller comprises a signal processing audio device for receiving the accelerator pedal signal and processing a pre-stored audio signal to output an audio signal corresponding to a current accelerator pedaling angle and strength; the sound producing mechanism is used to emit a warning sound according to the audio signal output by the controller.

10. The pedestrian alert device according to claim 9, wherein the controller further comprises a storage device for storing the pre-stored audio file.
